(19) United States
(12) Patent Application Publication
(10) Pub. No.: US 2022/0388545 A1
(43) Pub. Date: Dec. 8, 2022

(54) AUTONOMOUS DRIVING CONTROL APPARATUS AND METHOD THEREOF

(71) Applicants: Hyundai Motor Company, Seoul (KR); Kia Corporation, Seoul (KR)

(72) Inventors: Su Hong CHAE, Whasung-Si (KR); Ji Hwan PARK, Whasung-Si (KR); Young Jin SUNG, Whasung-Si (KR); Chan Hee JUNG, Whasung-Si (KR)

(73) Assignees: Hyundai Motor Company, Seoul (KR); Kia Corporation, Seoul (KR)

(21) Appl. No.: 17/545,657

(22) Filed: Dec. 8, 2021

(30) Foreign Application Priority Data
Jun. 7, 2021 (KR) 10-2021-0073544

(51) Int. Cl. B60W 60/00; B60W 40/02; B60W 30/14; B60W 50/14; B60S 1/08; H04W 4/44; G06V 20/56; G06V 10/762; G01S 17/95; G06N 20/00

(52) U.S. Cl. CPC B60W 60/00182; B60W 40/02; B60W 30/146; B60W 50/14; B60S 1/0833; H04W 4/44; G06V 20/588; G06V 10/762; G01S 17/95; G06N 20/00; B60W 2050/0054

(57) ABSTRACT

An apparatus and a method for controlling an autonomous vehicle depending on weather are provided. The apparatus obtains information including at least one of an image around the autonomous vehicle, sensing information of a Light Detection and Ranging (LiDAR) of the autonomous vehicle, sensing information of a rain sensor of the autonomous vehicle, an operation state of a windshield wiper of the autonomous vehicle, climate information through vehicle to everything (V2X) communication, an acceleration of the autonomous vehicle, or wheel sensor information of the autonomous vehicle and determines whether the climate state is an inclement weather state, based on the information including the at least one of the image around the autonomous vehicle, the sensing information of the LIDAR, the sensing information of the rain sensor, the operation state of the windshield wiper, the climate information through the V2X communication, the acceleration, or the wheel sensor information.

### CROSS-REFERENCE TO RELATED APPLICATION

The present application claims priority to Korean Patent Application No. 10-2021-0073544, filed on Jun. 7, 2021, the entire contents of which is incorporated herein for all purposes by this reference.

### BACKGROUND OF THE INVENTION

### Field of the Invention

The present invention relates to an autonomous driving control apparatus and a method thereof, and more particularly, relates to an apparatus and a method for controlling an autonomous vehicle.

### Description of Related Art

An autonomous vehicle needs a capability of adaptively coping with a surrounding situation which changes in real time while driving.

First of all, a reliable determination control function is required to mass produce and activate autonomous vehicles.

A semi-autonomous vehicle recently on the market basically performs driving, braking, and steering rather than a driver to reduce fatigue of the driver.

Unlike fully autonomous driving, semi-autonomous driving should keep focusing on the driving, for example, should allow the driver to continue to hold the steering wheel.

Recently, the semi-autonomous vehicle is loaded with a highway driving assist (HDA) function, a driver status warning (DSW) function of determining driver carelessness, such as drowsiness or gaze departure, and state abnormality and outputting a warning alarm through a cluster or the like, a driver awareness warning (DAW) function of determining whether the vehicle crosses the line and performs unstable driving by a front view camera, a forward collision-avoidance assist (FCA) or active emergency brake system (AEBS) function of performing emergency braking when detecting a head on collision, or the like to be sold.

When it is clement weather due to heavy rain, snow, fog, or the like, it may be difficult for a conventional autonomous vehicle to maintain driving performance because the autonomous vehicle incorrectly recognizes an object around the autonomous vehicle, because the autonomous vehicle does not recognize the object, or due to a slippery road.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an apparatus and a method for controlling an autonomous vehicle depending on weather.

Various aspects of the present invention provide an autonomous driving control apparatus of detecting inclement weather and requesting a driver to switch control authority of the autonomous vehicle, when it is determined that it is impossible to maintain an autonomous driving function, to improve stability of an autonomous driving system and a method thereof.

Various aspects of the present invention provide an autonomous driving control apparatus of limiting a speed or an acceleration of the autonomous vehicle in an autonomous driving mode, when detecting inclement weather, to reduce the risk of accident and preventing big accident to ensure safety of the driver and a method thereof.

Various aspects of the present invention provide an autonomous driving control apparatus of performing a minimum risk maneuver (MRM), when detecting inclement weather, to propose a safe function to the passenger of the autonomous vehicle and a method thereof.

Various aspects of the present invention provide an autonomous driving control apparatus of providing the driver or another vehicle with information related to inclement weather, using an additional device or a display device of the autonomous vehicle, when detecting the inclement weather, to increase safety and convenience of the driver or a user of the other vehicle and a method thereof.

The technical problems to be solved as various exemplary embodiments of the present invention are not limited to the aforementioned problems, and any other technical problems not mentioned herein will be clearly understood from the following description by those skilled in the art to which various exemplary embodiments of the present invention pertains.

According to various aspects of the present invention, an autonomous driving control apparatus may include a sensing device which is provided in an autonomous vehicle to obtain at least one of vehicle information of the autonomous vehicle or weather information around the autonomous vehicle, an inclement weather determining device that determines whether a climate state is an inclement weather state, according to the at least one of the vehicle information of the autonomous vehicle or the weather information around the autonomous vehicle, and an autonomous driving mode determining device that determines an autonomous driving mode of the autonomous vehicle depending on whether the climate state is the inclement weather state.

In various exemplary embodiments of the present invention, the vehicle information may include an image around the autonomous vehicle, sensing information of a light detection and ranging (LIDAR) of the autonomous vehicle, sensing information of a rain sensor of the autonomous vehicle, an operation state of a windshield wiper of the autonomous vehicle, an acceleration of the autonomous vehicle, or wheel sensor information of the autonomous vehicle. The weather information may include weather information obtained through vehicle to everything (V2X) communication.

In various exemplary embodiments of the present invention, the autonomous driving mode determining device may limit at least one of a speed or an acceleration of the autonomous vehicle or may request a user to switch control authority of the autonomous vehicle, when the climate state is determined by the inclement weather determining device as the inclement weather state and when the autonomous vehicle is performing autonomous driving thereof and may prohibit the autonomous driving of the autonomous vehicle from being activated, when the climate state is determined by the inclement weather determining device as the inclement weather state and when the autonomous vehicle is not performing the autonomous driving.

In various exemplary embodiments of the present invention, the autonomous driving control apparatus may further include a controller that transmits a signal corresponding to inclement weather to an external device through V2X communication, displays information related to the inclement weather on a display of the autonomous vehicle, or operates a windshield wiper of the autonomous vehicle, when the climate state is determined by the inclement weather determining device as the inclement weather state.

In various exemplary embodiments of the present invention, the inclement weather determining device may analyze an image around the autonomous vehicle, the image including at least one of an image in front of the autonomous vehicle, an image behind the autonomous vehicle, an image at a predetermined side of the autonomous vehicle, or an image in a ground direction, by a learning model based on machine learning, the learning model being previously learned, to determine whether the climate state is the inclement weather state.

In various exemplary embodiments of the present invention, the inclement weather determining device may analyze sensing information of a LIDAR of the autonomous vehicle by a learning model based on machine learning, the learning model being previously learned, to determine whether the climate state is the inclement weather state or may determine whether the climate state is the inclement weather state, based on whether a value of a noise component corresponding to the sensing information of the LIDAR is greater than a threshold of a predetermined noise component.

In various exemplary embodiments of the present invention, the inclement weather determining device may detect the noise component according to at least one of a change in position of a centroid component of a group obtained by clustering points detected by the LIDAR, a number of clustered groups, or a change in the number of the clustered groups.

In various exemplary embodiments of the present invention, the inclement weather determining device may determine whether the climate state is the inclement weather state, based on at least one of a reflectivity of light radiated to a windshield of the autonomous vehicle, the reflectivity being determined by the rain sensor, or a change in the reflectivity.

In various exemplary embodiments of the present invention, the inclement weather determining device may determine the climate state as the inclement weather state, when the reflectivity for all of the windshield is greater than a predetermined first threshold reflectivity or when the reflectivity for a portion of the windshield is greater than a predetermined second threshold reflectivity.

In various exemplary embodiments of the present invention, the inclement weather determining device may determine the climate state as the inclement weather state, when a windshield wiper of the autonomous vehicle operates greater than a predetermined threshold time in a high state.

In various exemplary embodiments of the present invention, the inclement weather determining device may determine the climate state as the inclement weather state, when a degree of slip of the autonomous vehicle, the degree being determined according to at least one of acceleration or wheel sensor information of the autonomous vehicle, is greater than a predetermined threshold of slip.

In various exemplary embodiments of the present invention, the inclement weather determining device may determine the climate state as the inclement weather state, when one or more values of a parameter corresponding to an image around the autonomous vehicle, a parameter corresponding to sensing information of a Light Detection and Ranging (LiDAR) of the autonomous vehicle, a parameter corresponding to sensing information of a rain sensor of the autonomous vehicle, a parameter value corresponding to an operation state of a windshield wiper of the autonomous vehicle, a parameter value corresponding to weather information obtained through V2X communication, or a parameter value corresponding to at least one of acceleration or wheel sensor information of the autonomous vehicle are greater than a predetermined first threshold preset for each parameter or when two or more parameters are greater than a predetermined second threshold preset for each parameter.

According to various aspects of the present invention, an autonomous driving control method may include obtaining, by a sensing device provided in an autonomous vehicle, at least one of vehicle information of the autonomous vehicle or weather information around the autonomous vehicle, determining, by an inclement weather determining device, whether a climate state is an inclement weather state, according to the at least one of the vehicle information of the autonomous vehicle or the weather information around the autonomous vehicle, and determining, by an autonomous driving mode determining device, an autonomous driving mode of the autonomous vehicle depending on whether the climate state is the inclement weather state.

In various exemplary embodiments of the present invention, the determining of the autonomous driving mode of the autonomous vehicle depending on whether the climate state is the inclement weather state by the autonomous driving mode determining device may include limiting, by the autonomous driving mode determining device, at least one of a speed or an acceleration of the autonomous vehicle or requesting a user to switch control authority of the autonomous vehicle, when the climate state is determined by the inclement weather determining device as the inclement weather state and when the autonomous vehicle is performing autonomous driving, and prohibiting, by the autonomous driving mode determining device, the autonomous driving of the autonomous vehicle from being activated, when the climate state is determined by the inclement weather determining device as the inclement weather state and when the autonomous vehicle is not performing the autonomous driving.

In various exemplary embodiments of the present invention, the autonomous driving control method may further include transmitting, by a controller, a signal corresponding to inclement weather to an external device through V2X communication, displaying, by the controller, information related to the inclement weather on a display of the autonomous vehicle, or operating, by the controller, a windshield wiper of the autonomous vehicle, when the climate state is determined by the inclement weather determining device as the inclement weather state.

In various exemplary embodiments of the present invention, the determining of whether the climate state is the inclement weather state by the inclement weather determining device may include analyzing, by the inclement weather determining device, an image around the autonomous vehicle, the image including at least one of an image in front of the autonomous vehicle, an image behind the autonomous vehicle, an image at a predetermined side of the autonomous vehicle, or an image in a ground direction, by a learning model based on machine learning, the learning model being previously learned, to determine whether the climate state is the inclement weather state.

In various exemplary embodiments of the present invention, the determining of whether the climate state is the inclement weather state by the inclement weather determining device may include analyzing, by the inclement weather determining device, sensing information of a LIDAR of the autonomous vehicle by a learning model based on machine learning, the learning model being previously learned, to determine whether the climate state is the inclement weather state or determining, by the inclement weather determining device, whether the climate state is the inclement weather state, based on whether a value of a noise component corresponding to the sensing information of the LIDAR is greater than a threshold of a predetermined noise component.

In various exemplary embodiments of the present invention, the determining of whether the climate state is the inclement weather state by the inclement weather determining device may include determining, by the inclement weather determining device, whether the climate state is the inclement weather state, based on at least one of a reflectivity of light radiated to a windshield of the autonomous vehicle, the reflectivity being determined by the rain sensor, or a change in the reflectivity.

In various exemplary embodiments of the present invention, the determining of whether the climate state is the inclement weather state by the inclement weather determining device may include determining, by the inclement weather determining device, the climate state as the inclement weather state, when a windshield wiper of the autonomous vehicle operates greater than a predetermined threshold time in a high state.

In various exemplary embodiments of the present invention, the determining of whether the climate state is the inclement weather state by the inclement weather determining device may include determining, by the inclement weather determining device, the climate state as the inclement weather state, when a degree of slip of the autonomous vehicle, the degree being determined according to at least one of acceleration or wheel sensor information of the autonomous vehicle, is greater than a predetermined threshold of slip.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a table where an automation level of an autonomous vehicle is defined;

FIG. 2 is a block diagram illustrating an autonomous driving control apparatus according to various exemplary embodiments of the present invention;

FIG. 3 is a block diagram illustrating an autonomous driving control apparatus according to various exemplary embodiments of the present invention;

FIG. 4 is a drawing illustrating that an autonomous driving control apparatus determines inclement weather based on a noise component of a light detection and ranging (LIDAR) according to various exemplary embodiments of the present invention;

FIG. 5 is a drawing illustrating that an autonomous driving control apparatus determines inclement weather based on sensing information of a rain sensor according to various exemplary embodiments of the present invention;

FIG. 6 is a flowchart illustrating a process where an autonomous driving control apparatus determines inclement weather and controls an autonomous vehicle according to various exemplary embodiments of the present invention;

FIG. 7 is a flowchart illustrating an autonomous driving control method according to various exemplary embodiments of the present invention; and

FIG. 8 is a flowchart illustrating an autonomous driving control method according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, various exemplary embodiments of the present invention will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present invention, a detailed description of well-known features or functions will be ruled out in order not to unnecessarily obscure the gist of the present invention.

In describing the components of the exemplary embodiment according to various exemplary embodiments of the present invention, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which various exemplary embodiments of the present invention pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

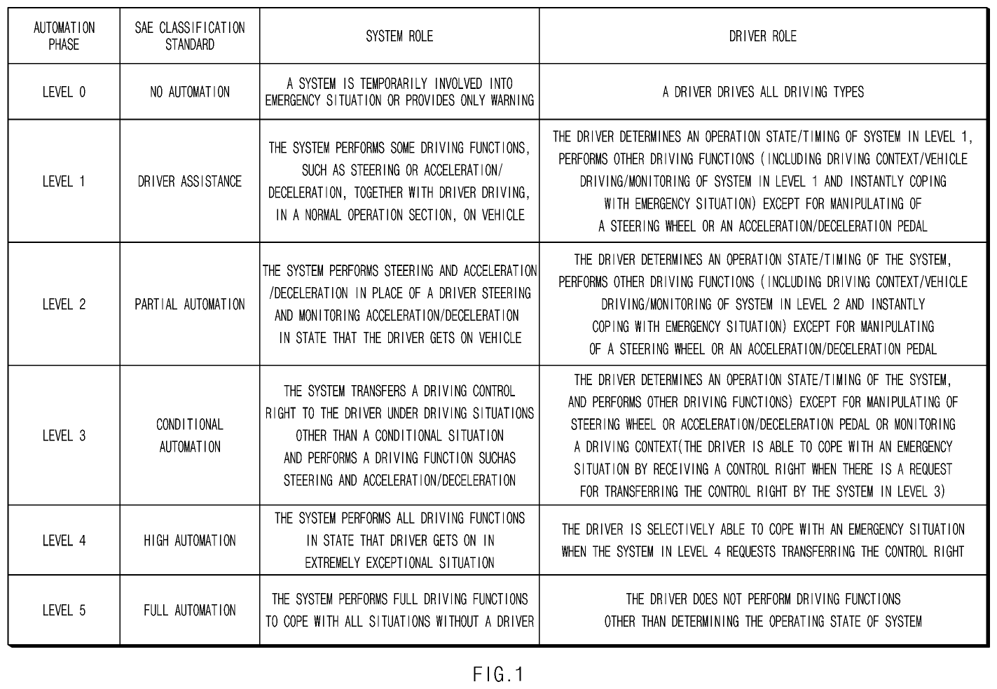

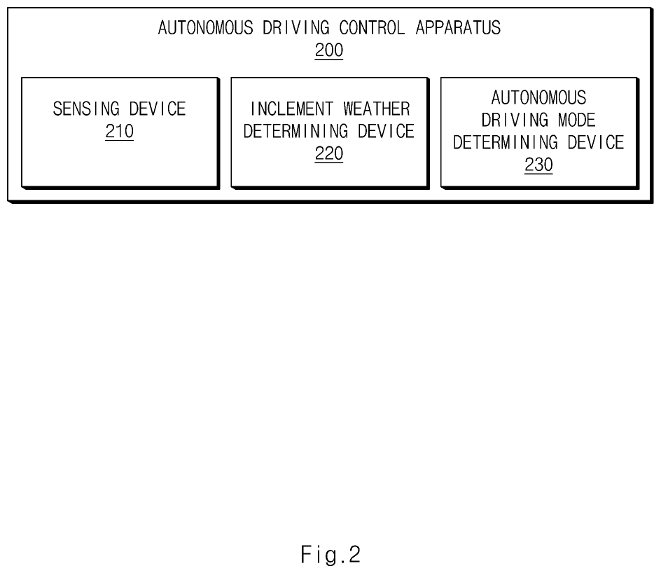

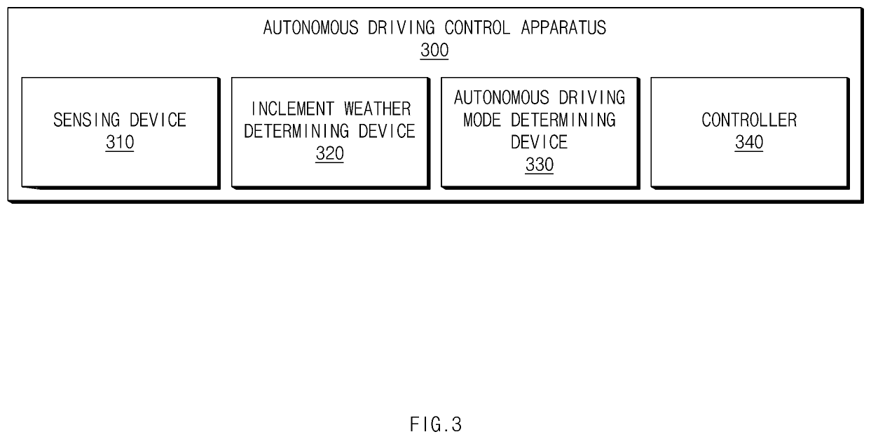

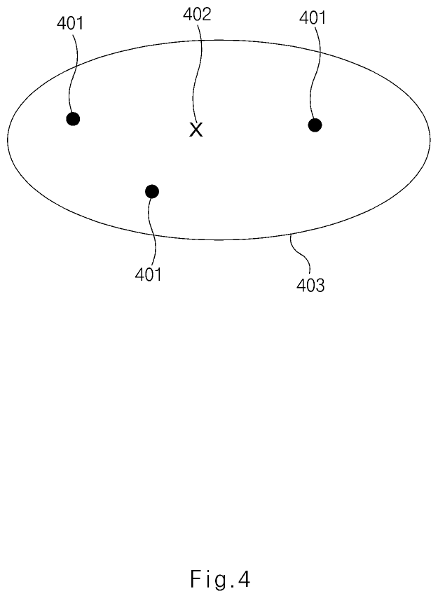

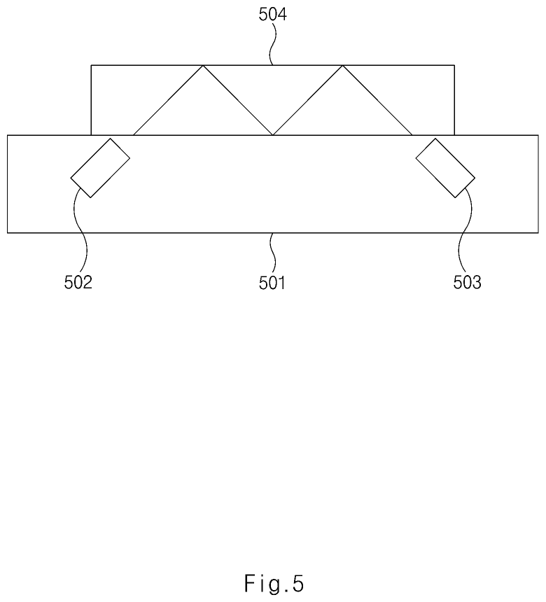

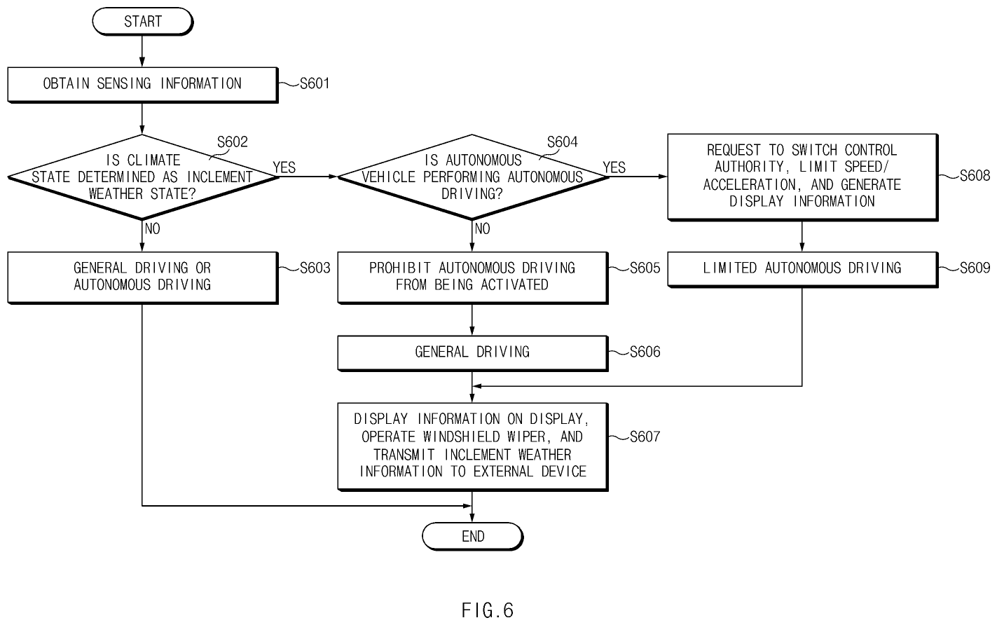

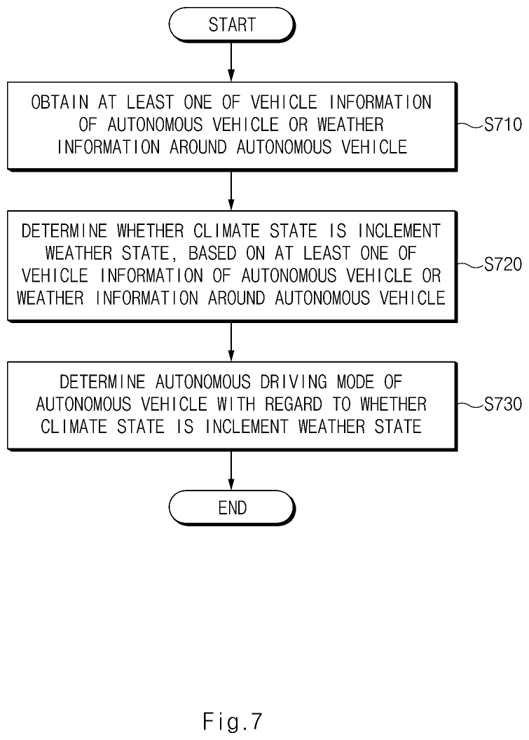

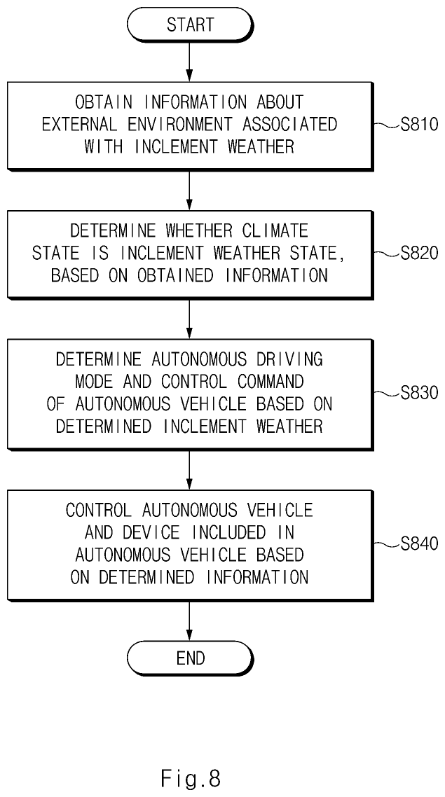

Hereinafter, embodiments of the present invention will be described in detail with reference to FIG. 1, FIG. 2, FIG. 3, FIG. 4, FIG. 5, FIG. 6, FIG. 7, and FIG. 8.

FIG. 1 is a table where an automation level of an autonomous vehicle is defined.

An autonomous vehicle refers to a vehicle which recognizes a driving environment by itself to determine risk, controls its driving route to minimize driving manipulation of a driver, and drives itself

Finally, the autonomous vehicle refers to a vehicle configured for performing driving, steering, and parking without influence of persons and is focused on a vehicle where an autonomous driving technology, which is the core foundation of the autonomous vehicle,—that is, a capability of operating the vehicle without active control or monitoring of the driver—is developed to the highest degree.

Referring to FIG. 1, the driving environment is monitored by the driver in automation levels LEVELs 0 to 2. On the other hand, the driving environment is monitored by the automated driving system in automation levels LEVELs 3 to 5.

However, the concept of autonomous vehicles currently on the market may include an intermediate automation level to a fully autonomous vehicle and may correspond to a goal-oriented concept premised on the mass production and commercialization of fully autonomous vehicles.

An autonomous driving control method according to exemplary embodiments of the present invention is applicable to an autonomous vehicle corresponding to LEVEL 2 (partial automation) and LEVEL 3 (conditional automation) in autonomous driving automation levels shown in FIG. 1, but is not necessarily limited thereto, and is applicable to an autonomous vehicle supporting a plurality of various automation levels.

An automation level of the autonomous vehicle may be classified as shown in a table of FIG. 1 on the basis of society of automotive engineers (SAE).

FIG. 2 is a block diagram illustrating an autonomous driving control apparatus according to various exemplary embodiments of the present invention.

Referring to FIG. 2, an autonomous driving control apparatus 200 may include a sensing device 210, an inclement weather determining device 220, and an autonomous driving mode determining device 230.

As an example, the autonomous driving control apparatus 200 may be integrally configured with a vehicle or may be implemented as a separate configuration in a form of being installed/attached to the vehicle. Alternatively, a part of the autonomous driving control apparatus 200 may be integrally configured with the vehicle or the other may be implemented as a separate configuration in a form of being installed/attached to the vehicle.

The sensing device 210 may be provided in an autonomous vehicle to obtain at least one of vehicle information of the autonomous vehicle or weather information around the autonomous vehicle.

As an example, the vehicle information may include an image around the autonomous vehicle, sensing information of a light detection and ranging (LIDAR) of the autonomous vehicle, sensing information of a rain sensor of the autonomous vehicle, an operation state of a windshield wiper of the autonomous vehicle, an acceleration of the autonomous vehicle, or wheel sensor information of the autonomous vehicle.

As an example, the weather information may include weather information obtained through vehicle to everything (V2X) communication. As an example, the sensing device 210 may be connected to a camera provided in the autonomous vehicle to obtain an image around the autonomous vehicle by the camera.

In detail, the sensing device 210 may obtain an image around the autonomous vehicle by at least one of an around view monitoring (AVM) camera, a surround view monitor (SVM) camera, a drive video record system (DVRS) camera, a camera monitor system (CMS) camera, a blind-spot view monitor (BVM) camera, or a line detection camera, which is provided in the autonomous vehicle.

As an example, the sensing device 210 may be connected to the LIDAR of the autonomous vehicle to obtain sensing information of the LIDAR by the LIDAR.

As an example, the sensing device 210 may be connected to the rain sensor of the autonomous vehicle to obtain sensing information of the rain sensor by the rain sensor.

As an example, the sensing device 210 may be connected to a windshield wiper system of the autonomous vehicle to obtain information related to an operation state of a windshield wiper by the windshield wiper system of the autonomous vehicle.

As an example, the sensing device 210 may be connected to a V2X communication module of the autonomous vehicle to obtain climate information announced in a corresponding area of the autonomous vehicle from a server or a pedestrian communication terminal or obtain climate information determined by another vehicle from the other vehicle, by the V2X communication module.

As an example, the sensing device 210 may be connected to an acceleration sensor or a wheel sensor of the autonomous vehicle to obtain acceleration or wheel sensor information of the autonomous vehicle by the acceleration sensor or the wheel sensor.

As an example, the sensing device 210 may be directly or indirectly connected to the inclement weather determining device 220 through wireless or wired communication to transmit information including at least one of an image around the autonomous vehicle, sensing information of the LIDAR, sensing information of the rain sensor, an operation state of the windshield wiper, climate information through V2X communication, acceleration, or wheel sensor information.

The inclement weather determining device 220 and the autonomous driving mode determining device 230 may be implemented in a form of hardware, may be implemented in a form of software, or may be implemented in a form of a combination thereof. The inclement weather determining device 220 and the autonomous driving mode determining device 230 may be implemented as, but not limited to, a microprocessor. Furthermore, the inclement weather determining device 220 and the autonomous driving mode determining device 230 may perform a variety of data processing, calculation, and the like described below.

The inclement weather determining device 220 may determine whether the climate state is an inclement weather state, based on at least one of vehicle information of the autonomous vehicle or weather information around the autonomous vehicle.

As an example, the inclement weather determining device 220 may determine whether the climate state is the inclement weather state, based on information including at least one of an image around the autonomous vehicle, sensing information of the LIDAR, sensing information of the rain sensor, an operation state of the windshield wiper, weather information obtained through V2X communication, acceleration, or wheel sensor information.

As an example, the inclement weather determining device 220 may determine whether the climate state of a position where the autonomous vehicle is present is the inclement weather state.

As an example, the inclement weather determining device 220 may analyze the image around the autonomous vehicle, including an image in front of the autonomous vehicle, an image behind the autonomous vehicle, an image at the side of the autonomous vehicle, or an image in a ground direction, by a learning model based on machine learning, which is previously learned, to determine whether the climate state is the inclement weather state.

As an example, the inclement weather determining device 220 may determine whether the climate state is the inclement weather state by use of the result of analyzing the image around the autonomous vehicle by the learning model based on the machine learning, which is previously learned, as a determination element.

Because there may be a difference due to rain, snow, fog, or the like between the image around the autonomous vehicle in the climate state determined as the normal state and the image around the autonomous vehicle in the climate state determined as the inclement weather state, the inclement weather determining device 220 may apply the learning model based on the machine learning, which is learned to detect an image captured in the inclement weather state by a pixel value or the like of the image, to the obtained image around the autonomous vehicle to determine the inclement weather state.

As an example, the learning model learned to determine inclement weather by the image may include a learning model separately learned for the autonomous vehicle or a learning model learned by the image for a plurality of vehicles for each server which manages the autonomous vehicle.

As various exemplary embodiments of the present invention, the learning model learned to determine inclement weather by the image may include a learning model learned in the step of developing the autonomous vehicle.

As an example, the inclement weather determining device 220 may analyze sensing information of the LIDAR by the learning model based on the machine learning, which is previously learned, to determine whether the climate state is the inclement weather state or may determine whether the climate state is the inclement weather state, based on whether a value of a noise component corresponding to the sensing information of the LIDAR is greater than a threshold of a predetermined noise component.

As an example, the inclement weather determining device 220 may determine whether the climate state is the inclement weather state by use of the result of analyzing the sensing information of the LIDAR by the learning model based on the machine learning, which is previously learned, or the noise component corresponding to the sensing information of the LIDAR as a determination element.

In a process where the LIDAR radiates light in the inclement weather state, detects reflected light reflected from a target, and detects a distance from the autonomous vehicle to the target, an unexpected error may occur due to rain, snow, fog, or the like.

Thus, because there may be a difference between information related to a distance to the target or about reflected light, which is detected in the inclement weather state, and information related to a distance or reflected light in the normal climate state, the inclement weather determining device 220 may apply a learning model learned to detect LIDAR sensing information detected in the inclement weather state by the information related to the distance to the detected target or the information related to the detected reflected light to the obtained LIDAR sensing information to determine the inclement weather state.

As an example, the inclement weather determining device 220 may detect a noise component based on the sensing information of the LIDAR and may determine the climate state as the inclement weather state, when the detected noise component has a value of a threshold or more.

In detail, the inclement weather determining device 220 may detect the noise component based on at least one of a change in position of a centroid component of a group obtained by clustering points detected by the LIDAR, the number of the clustered groups, or a change in the number of the clustered groups.

A description will be provided in detail of contents of detecting, by the inclement weather determining device 220, the noise component based on the at least one of the change in the position of the centroid component of the group obtained by clustering the points detected by the LIDAR, the number of the clustered groups, or the change in the number of the clustered groups.

As an example, the inclement weather determining device 220 may determine whether the climate state is the inclement weather state, based on at least one of a reflectivity of light emitted to a windshield of the autonomous vehicle, which is detected by the rain sensor, or a change in the reflectivity.

As an example, the inclement weather determining device 220 may determine whether the climate state is the inclement weather state, by use of at least one of the reflectivity of the light emitted to the windshield of the autonomous vehicle, which is detected by the rain sensor, or the change in the reflectivity as a determination element.

The rain sensor of the autonomous vehicle may emit light to the windshield and may detect reflected light reflected from the windshield to obtain information related to the determined reflectivity.

As an example, the inclement weather determining device 220 may determine that the climate state is the inclement weather state, when a reflectivity of the light, which is detected by the rain sensor, or a change in the reflectivity of the light is greater than a predetermined threshold.

As an example, when a reflectivity for all of the windshield is greater than a predetermined first threshold reflectivity or when a reflectivity for a portion of the windshield is greater than a predetermined second threshold reflectivity, the inclement weather determining device 220 may determine the climate state as the inclement weather state.

As an example, the first threshold reflectivity may be set to be lower than the second threshold reflectivity.

As there are foreign substances on all or a portion of the windshield, because there may occur a difference in reflectivity or a change in the reflectivity between the inclement weather state and the normal climate state, the inclement weather determining device 220 may determine whether the climate state is the inclement weather state, based on whether a range greater than the first threshold reflectivity is the entire range of the windshield or whether a range greater than the second threshold reflectivity in the windshield is greater than a reference range.

As an example, when the windshield wiper operates greater than a predetermined threshold time in a high state, the inclement weather determining device 220 may determine the climate state as the inclement weather state.

As an example, the inclement weather determining device 220 may determine that the climate state is the inclement weather state, by use of a time when the windshield wiper operates in the high state as a determination element.

The windshield wiper of the autonomous vehicle may operate in a high state where it operates at a high speed or in a low state where it operates at a low speed.

When the climate state is the inclement weather state, because the windshield wiper of the autonomous vehicle is able to manually or automatically operate in the high state, the inclement weather determining device 220 may determine whether the windshield wiper operates greater than a predetermined threshold time in the high state to determine whether the climate state is the inclement weather state.

As an example, the weather information through the V2X communication may include at least one of weather information announced in an area of the autonomous vehicle or weather information determined by another vehicle around the autonomous vehicle, which is received through the V2X communication.

As an example, the inclement weather determining device 220 may determine whether the climate state is the inclement weather state, by use of the weather information through the V2X communication as a determination element.

As an example, the inclement weather determining device 220 may determine whether the climate state is the inclement weather state based on weather information announced in an area where there is an autonomous vehicle, which is obtained from a server via a V2X communication module of the autonomous vehicle or weather information determined by another vehicle around the autonomous vehicle, which is obtained from the other vehicle via the V2X communication module of the autonomous vehicle.

As an example, the inclement weather determining device 220 may determine the climate state as an inclement weather state, when the announced weather information is rain, snow, fog, or the like, and may determine the climate state as the inclement weather state, when the climate information determined by another vehicle around the autonomous vehicle is the inclement weather state.

As an example, when a degree of slip of the autonomous vehicle, which is determined based on at least one of acceleration or wheel sensor information, is greater than a predetermined threshold of slip, the inclement weather determining device 220 may determine the climate state as the inclement weather state.

As an example, the inclement weather determining device 220 may determine whether the climate state is the inclement weather state, by use of the degree of slip of the autonomous vehicle, which is determined based on the at least one of the acceleration or the wheel sensor information, as a determination element.

Furthermore, the inclement weather determining device 220 may determine whether the climate state is the inclement weather state by information detected by a separate other sensor configured for sensing snow or rain, which is provided near a wheel cover of the autonomous vehicle or on a roof of the autonomous vehicle.

As an example, the inclement weather determining device 220 may determine the degree of slip of the autonomous vehicle, by a difference between an acceleration of the autonomous vehicle, which is obtained by the acceleration sensor, and acceleration determined based on information obtained by the wheel sensor information and may determine whether the climate state is the inclement weather state based on whether the determined degree of slip is greater than a predetermined threshold.

As an example, the inclement weather determining device 220 may determine the climate state as the inclement weather state, when one or more values of a parameter corresponding to an image around the autonomous vehicle, a parameter value corresponding to sensing information of the LIDAR, a parameter value corresponding to sensing information of the rain sensor, a parameter value corresponding to an operation state of the windshield wiper, a parameter value corresponding to climate information through V2X communication, or a parameter value corresponding to at least one of acceleration or wheel sensor information are greater than a predetermined first threshold preset for each parameter or when two or more parameters are greater than a predetermined second threshold preset for each parameter.

As an example, the first threshold may be set to be higher than the second threshold.

The inclement weather determining device 220 may determine a condition where a parameter for any one of a plurality of determination elements is greater than a high threshold (a first threshold) and a condition where two or more parameters are greater than a low threshold (a second threshold) to determine whether the climate state is the inclement weather state.

When the climate state is determined as the inclement weather state and when the autonomous vehicle is performing autonomous driving, the autonomous driving mode determining device 230 may limit at least one of a speed or an acceleration of the autonomous vehicle or may request the user to switch control authority.

As an example, the autonomous driving mode determining device 230 may be connected to an autonomous driving system of the autonomous vehicle to receive information related to whether the autonomous vehicle is performing autonomous driving.

As an example, limiting the at least one of the speed or the acceleration of the autonomous vehicle by the autonomous driving mode determining device 230 may be performed when the autonomous vehicle performs autonomous driving in an environment of any one of LEVELs 3 to 5 of autonomous driving of FIG. 1. Requesting the user to switch the control authority may be performed when the autonomous vehicle performs autonomous driving in an environment of any one of LEVELs 3 and 4 of the autonomous driving of FIG. 1.

As an example, the autonomous driving mode determining device 230 may limit at least one of the speed or the acceleration of the autonomous vehicle, by an autonomous driving system of the autonomous vehicle.

As an example, the autonomous driving mode determining device 230 may request the user to switch control authority, by a voice or a screen output on an AVN or the like of the autonomous vehicle.

When the climate state is determined as the inclement weather state and when the autonomous vehicle is not performing the autonomous driving, the autonomous driving mode determining device 230 may prohibit the autonomous driving of the autonomous vehicle from being activated.

As an example, the autonomous driving mode determining device 230 may prohibit the autonomous driving of the autonomous vehicle from being activated, by the autonomous driving system of the autonomous vehicle.

FIG. 3 is a block diagram illustrating an autonomous driving control apparatus according to various exemplary embodiments of the present invention.

Referring to FIG. 3, an autonomous driving control apparatus 300 may include a sensing device 310, an inclement weather determining device 320, an autonomous driving mode determining device 330, and a controller 340.

Because the sensing device 310, the inclement weather determining device 320, and the autonomous driving mode determining device 330 are the same as a sensing device 210, an inclement weather determining device 220, and an autonomous driving mode determining device 230 of FIG. 2, a detailed description thereof will be omitted herein.

As an example, when it is determined that the climate state is the inclement weather state by the inclement weather determining device 320, the autonomous driving mode determining device 330 may generate a command to control a vehicle (speed and acceleration), control a windshield wiper, control to display inclement weather information on a display, or control information transmission by control of a V2X communication module to an external device.

As an example, the autonomous driving mode determining device 330 may transmit the generated command to control the vehicle (speed and acceleration), the windshield wiper, or information transmission by the control of the V2X communication module to the external device to the controller 340.

As an example, the controller 340 may be connected to an autonomous driving system and may control a driving system of the autonomous vehicle by the autonomous driving system to limit at least one of a speed or an acceleration of the autonomous vehicle not to be greater than a predetermined reference value.

As an example, the controller 340 may request a user to switch control authority by a visual or audible notification on an audio, video, navigation (AVN), a cluster, a head up display (HUD), or the like of the autonomous vehicle.

When the climate state is determined as the inclement weather state and when the autonomous vehicle is not performing autonomous driving, the controller 340 may prohibit the autonomous driving of the autonomous vehicle from being activated.

As an example, when the climate state is determined as the inclement weather state and when the autonomous vehicle is not performing the autonomous driving, although an autonomous driving activation signal is input on the autonomous driving system, the controller 340 may control such that autonomous driving is not activated and may provide the user with a notification that the autonomous driving is not activated.

When the climate state is determined as the inclement weather state, the controller 340 may transmit a signal corresponding to inclement weather to the external device through V2X communication, may display information related to the inclement weather on the display of the autonomous vehicle, or may operate the windshield wiper of the autonomous vehicle.

As an example, the controller 340 may be connected to a V2X communication module of the autonomous vehicle and may transmit the signal corresponding to the inclement weather to another vehicle, a server, a communication module of a pedestrian, or the like, via the V2X communication module, when the climate state is determined as the inclement weather state.

As an example, when the climate state is determined as the inclement weather state, the controller 340 may display the information related to the inclement weather on the AVN, the cluster, the HUD, or the like of the autonomous vehicle.

As an example, the controller 340 may be connected to a windshield wiper system of the autonomous vehicle to operate the windshield wiper, when the climate state is determined as the inclement weather state.

FIG. 4 is a drawing illustrating that an autonomous driving control apparatus determines inclement weather based on a noise component of a Light Detection and Ranging (LiDAR) according to various exemplary embodiments of the present invention.

Referring to FIG. 4, the LIDAR of the autonomous vehicle may radiate light to the periphery of the autonomous vehicle and may detect reflected light reflected from a target to detect specific points 401 determined that the reflected target is present.

An autonomous driving control apparatus 200 of FIG. 2 may detect a noise component based on at least one of a change in position of a centroid component 402 of a group 403 obtained by clustering the points 411 detected by the LIDAR, the number of the clustered groups 403, or a change in the number of the clustered groups 403.

As an example, the autonomous driving control apparatus 200 may determine a Euclidean distance between the points 401 detected by the LIDAR and may cluster points where the Euclidean distance is less than a reference distance into one group to generate the clustered group 403.

At the present time, the plurality of clustered groups 403 may be generated.

As an example, the centroid 402 of the clustered group 403 may change in position according to sensing information of the LIDAR, which is collected in real time. The autonomous driving control apparatus 200 may determine the detected points 401 or the clustered group 403 as a noise component, when the centroid 402 of the clustered group 403 changes in position to be greater than a threshold distance within a threshold time.

As an example, when the number of the clustered groups 403 is greater than a first threshold number or when a change in the number of the clustered groups 403 within the threshold time is greater than a second threshold number, the autonomous driving control apparatus 200 may determine the detected points 401 or the clustered group 403 as a noise component.

Because the centroid 402 of the clustered group 403 changes in position to be greater than the threshold distance within the threshold time, due to snow, rain, fog, or the like, when the climate state is the inclement weather state, because the number of the clustered groups 403 is large, or because a change in the number of the clustered groups 403 within the threshold time is large, the autonomous driving control apparatus 200 may detect noise by sensing information of the LIDAR to determine whether the climate state is the inclement weather state.

FIG. 5 is a drawing illustrating that an autonomous driving control apparatus determines inclement weather based on sensing information of a rain sensor according to various exemplary embodiments of the present invention.

Referring to FIG. 5, a rain sensor 501 may include a light-emitting diode (LED) 502 and an optical sensor 503.

The rain sensor 501 may radiate light to a windshield 504 of an autonomous vehicle through the light-emitting diode (LED) 502.

After radiating the light, the rain sensor 501 may detect reflected light reflected from the windshield 504 by the optical sensor 503.

The rain sensor 501 may determine a reflectivity of light based on the ratio of intensity of the reflected light detected by the optical sensor 503 to intensity of light radiated through the LED 502.

An autonomous driving control apparatus 200 may receive information related to the reflectivity from the rain sensor 501.

When a reflectivity for all of the windshield is greater than a predetermined first threshold reflectivity or when a reflectivity for a portion of the windshield is greater than a predetermined second threshold reflectivity, based on the reflectivity received from the rain sensor 501, the autonomous driving control apparatus 200 may determine the climate state as the inclement weather state.

When there is a water drop by snow or rain on the windshield, the autonomous driving control apparatus 200 may determine an inclement weather state in the above method, using a change in reflectivity.

FIG. 6 is a flowchart illustrating a process where an autonomous driving control apparatus determines inclement weather and controls an autonomous vehicle according to various exemplary embodiments of the present invention.

Referring to FIG. 6, in S601, an autonomous vehicle 200 of FIG. 2 may obtain sensing information.

As an example, for an autonomous vehicle having an autonomous driving function of LEVEL 3 or more, the autonomous driving control apparatus 200 may obtain sensing information including at least one of an image around the autonomous vehicle, sensing information of a Light Detection and Ranging (LiDAR) of the autonomous vehicle, sensing information of a rain sensor of the autonomous vehicle, an operation state of a windshield wiper of the autonomous vehicle, climate information through V2X communication, an acceleration of the autonomous vehicle, or wheel sensor information of the autonomous vehicle.

After obtaining the sensing information in S601, in S602, the autonomous driving control apparatus 200 may identify whether the climate state is determined as an inclement weather state.

As an example, the autonomous driving control apparatus 200 may determine whether the climate state is the inclement weather state, based on the sensing information including the at least one of the image around the autonomous vehicle, the sensing information of the LIDAR, the sensing information of the rain sensor, the operation state of the windshield wiper, climate information through the V2X communication, the acceleration, or the wheel sensor information.

After identifying whether the climate state is determined as the inclement weather state in S602, when it is identified that the climate state is not determined as the inclement weather state, in S603, the autonomous driving control apparatus 200 may control the autonomous vehicle to travel by general driving or autonomous driving.

As an example, when it is identified that the climate state is not determined as the inclement weather state, the autonomous driving control apparatus 200 may control the autonomous vehicle to travel by general driving without change, when the autonomous vehicle is traveling by the general driving, and may control the autonomous vehicle to perform autonomous driving without change, when the autonomous vehicle is performing the autonomous driving.

After identifying whether the climate state is determined as the inclement weather state in S602, when it is identified that the climate state is determined as the inclement weather state, in S604, the autonomous driving control apparatus 200 may identify whether the autonomous vehicle is performing autonomous driving.

As an example, the autonomous driving control apparatus 200 may be connected to an autonomous driving system of the autonomous vehicle to identify whether the autonomous vehicle is performing the autonomous driving, by the autonomous driving system.

After identifying whether the autonomous vehicle is performing the autonomous driving in S604, when it is identified that the autonomous vehicle is not performing the autonomous driving, in S605, the autonomous driving control apparatus 200 may prohibit the autonomous driving from being activated.

As an example, when it is identified that the autonomous vehicle is not performing the autonomous driving, the autonomous driving control apparatus 200 may control such that the autonomous driving is not activated and may provide the user with a notification that the autonomous driving is not activated by an AVN, a cluster, an HUD, or the like, although an autonomous driving activation signal is input on the autonomous driving system, when the climate state is determined as the inclement weather state and when the autonomous vehicle is not performing the autonomous driving.

After prohibiting the autonomous driving from being activated in S605, in S606, the autonomous driving control apparatus 200 may control the autonomous vehicle to travel by the general driving.

As an example, the autonomous driving control apparatus 200 may prohibit the autonomous vehicle from entering an autonomous driving mode and may control the autonomous vehicle depending on a general driving environment to travel by the general driving.

After controlling the autonomous vehicle to travel by the general driving in S606, in S607, the autonomous driving control apparatus 200 may display information on a display, may operate a windshield wiper, and may transmit inclement weather information to an external device.

As an example, the autonomous driving control apparatus 200 may output information related to inclement weather on a display such as an AVN, a cluster, or an HUD.

Furthermore, the autonomous driving control apparatus 200 may operate the windshield wiper by a windshield wiper system to obtain a view of the autonomous vehicle.

The autonomous driving control apparatus 200 may transmit information related to inclement weather to another vehicle around the autonomous vehicle, a server, or a terminal of a pedestrian around the autonomous vehicle, by a V2X communication module of the autonomous vehicle.

After identifying whether the autonomous vehicle is performing the autonomous driving in S604, when it is identified that the autonomous vehicle is performing the autonomous driving, in S608, the autonomous driving control apparatus 200 may request a driver of the autonomous vehicle to switch control authority, may limit a speed/acceleration of the autonomous vehicle, and may generate display information related to inclement weather.

As an example, when it is identified that the autonomous vehicle is performing the autonomous driving, the autonomous driving control apparatus 200 may request the driver to switch control authority, by an AVN, a cluster, an HUD, or the like.

As an example, the autonomous driving control apparatus 200 may limit the speed or the acceleration of the autonomous vehicle not to be greater than a reference value, by the autonomous driving system of the autonomous vehicle.

As an example, the autonomous driving control apparatus 200 may generate information related to inclement weather, information related to contents that autonomous driving is performed in its limited state due to inclement weather, or information related to contents requesting to switch control authority.

After requesting the driver of the autonomous vehicle to switch the control authority, limiting the speed/acceleration of the autonomous vehicle, and generating the display information related to the inclement weather in S608, in S609, the autonomous driving control apparatus 200 may control the autonomous vehicle to travel by the limited autonomous driving.

As an example, the autonomous driving control apparatus 200 may control the autonomous vehicle to perform the limited autonomous driving in the state where the speed or the acceleration is limited.

After controlling the autonomous vehicle to travel by the limited autonomous driving in S609, in S607, the autonomous driving control apparatus 200 may display information on the display, may operate the windshield wiper, and may transmit inclement weather information to the external device.

FIG. 7 is a flowchart illustrating an autonomous driving control method according to various exemplary embodiments of the present invention.

Referring to FIG. 7, the autonomous driving control method may include obtaining (S710) at least one of vehicle information of an autonomous vehicle or weather information around the autonomous vehicle, determining (S720) whether the climate state is an inclement weather state based on the at least one of the vehicle information of the autonomous vehicle or the weather information around the autonomous vehicle, and determining (S730) an autonomous driving mode of the autonomous vehicle with regard to whether the climate state is the inclement weather state.

The obtaining (S710) of the at least one of the vehicle information of the autonomous vehicle or the weather information around the autonomous vehicle may be performed by a sensing device 210 of FIG. 2.

The determining (S720) of whether the climate state is the inclement weather state, according to the at least one of the vehicle information of the autonomous vehicle or the weather information around the autonomous vehicle may be performed by an inclement weather determining device 220 of FIG. 2.

As an example, the determining (S720) of whether the climate state is the inclement weather state by the inclement weather determining device 220 may include analyzing, by the inclement weather determining device 220, the image around the autonomous vehicle, including at least one of an image in front of the autonomous vehicle, an image behind the autonomous vehicle, an image at the side of the autonomous vehicle, or an image in a ground direction, by a learning model based on machine learning, which is previously learned, to determine whether the climate state is the inclement weather state.

As an example, the determining (S720) of whether the climate state is the inclement weather state by the inclement weather determining device 220 may include analyzing, by the inclement weather determining device 220, sensing information of a LIDAR of the autonomous vehicle by the learning model based on the machine learning, which is previously learned, to determine whether the climate state is the inclement weather state or determining, by the inclement weather determining device 220, whether the climate state is the inclement weather state, based on whether a value of a noise component corresponding to the sensing information of the LIDAR is greater than a threshold of a predetermined noise component.

As an example, the determining (S720) of whether the climate state is the inclement weather state by the inclement weather determining device 220 may include determining, by the inclement weather determining device 220, whether the climate state is the inclement weather state, based on at least one of a reflectivity of light radiated to a windshield of the autonomous vehicle, which is determined by a rain sensor of the autonomous vehicle, or a change in the reflectivity.

As an example, the determining (S720) of whether the climate state is the inclement weather state by the inclement weather determining device 220 may include determining, by the inclement weather determining device 220, the climate state as the inclement weather state, when the windshield wiper of the autonomous vehicle operates greater than a predetermined threshold time in a high state.

As an example, the determining (S720) of whether the climate state is the inclement weather state by the inclement weather determining device 220 may include determining, by the inclement weather determining device 220, the climate state as the inclement weather state, when a degree of slip of the autonomous vehicle, which is determined based on at least one of acceleration or wheel sensor information of the autonomous vehicle, is greater than a predetermined threshold of slip.

The determining (S730) of the autonomous driving mode of the autonomous vehicle with regard to whether the climate state is the inclement weather state may be performed by an autonomous driving mode determining device 230 of FIG. 2.

As an example, the determining (S730) of the autonomous driving mode of the autonomous vehicle with regard to whether the climate state is the inclement weather state by the autonomous driving mode determining device 230 may include limiting, by the autonomous driving mode determining device 230, at least one of a speed or an acceleration of the autonomous vehicle or requesting, by the autonomous driving mode determining device 230, a user to switch control authority, when the climate state is determined as the inclement weather state and when the autonomous vehicle is performing autonomous driving thereof and prohibiting, by the autonomous driving mode determining device 230, the autonomous driving of the autonomous vehicle from being activated, when the climate state is determined as the inclement weather state and when the autonomous vehicle is not performing the autonomous driving.

FIG. 8 is a flowchart illustrating an autonomous driving control method according to various exemplary embodiments of the present invention.

Referring to FIG. 8, the autonomous driving control method may include obtaining (S810) information related to an external environment associated with inclement weather, determining (S820) whether the climate state is an inclement weather state based on the obtained information, determining (S830) an autonomous driving mode and a control command of an autonomous vehicle based on the determined inclement weather, and controlling (S840) the autonomous vehicle and a device included in the autonomous vehicle based on the determined information.

The obtaining (S810) of the information related to the external environment associated with the inclement weather may include obtaining, by a sensing device 210 of FIG. 2, an image around the autonomous vehicle by a camera, obtaining, by the sensing device 210, sensing information of a LIDAR by the LIDAR, obtaining, by the sensing device 210, sensing information of a rain sensor by the rain sensor, obtaining, by the sensing device 210, an operation state of a windshield wiper by a windshield wiper system, obtaining, by the sensing device 210, climate information by a V2X communication module, obtaining, by the sensing device 210, an acceleration of the autonomous vehicle by an acceleration sensor, and obtaining, by the sensing device 210, wheel sensor information by a wheel sensor.

The determining (S820) of whether the climate state is the inclement weather state based on the obtained information may include at least one of analyzing, by an inclement weather determining device 220 of FIG. 2, the image around the autonomous vehicle by a learning model based on machine learning, which is previously learned, analyzing, by the inclement weather determining device 220, sensing information of the LIDAR by the learning model based on the machine learning, which is previously learned, identifying, by the inclement weather determining device 220, whether a value of a noise component corresponding to the sensing information of the LIDAR is greater than a threshold of a predetermined noise component, analyzing, by the inclement weather determining device 220, at least one of a reflectivity of light radiated to a windshield of the autonomous vehicle, which is determined by a rain sensor, or a change in the reflectivity, identifying, by the inclement weather determining device 220, whether the windshield wiper operates greater than a predetermined threshold in a high state, analyzing, by the inclement weather determining device 220, weather information including weather information announced in an area of the autonomous vehicle or climate state determined by another vehicle around the autonomous vehicle, and identifying, by the inclement weather determining device 220, whether a degree of slip of the autonomous vehicle, which is determined based on at least one of acceleration or wheel sensor information, is greater than a predetermined threshold of slip.

The determining (S830) of the autonomous driving mode and the control command of the autonomous vehicle based on the determined inclement weather may include at least one of determining, by an autonomous driving mode determining device 230 of FIG. 2, a control command to limit at least one of a speed or an acceleration of the autonomous vehicle, determining, by the autonomous driving mode determining device 230, a control command to requesting a user to switch control authority, determining, by the autonomous driving mode determining device 230, a control command to prohibit autonomous driving of the autonomous vehicle from being activated, determining, by the autonomous driving mode determining device 230, a control command to transmit a signal corresponding to inclement weather to an external device through V2X communication, or determining a control command to operate a windshield wiper of the autonomous vehicle.

As an example, the controlling (S840) of the autonomous vehicle and the device included in the autonomous vehicle based on the determined information may include limiting, by a controller 340 of FIG. 3, at least one of a speed or an acceleration of the autonomous vehicle or requesting, by the controller 340, the user to switch control authority, when the climate state is determined as the inclement weather state and when the autonomous vehicle is performing the autonomous driving,

As an example, the controlling (S840) of the autonomous vehicle and the device included in the autonomous vehicle based on the determined information may include prohibiting, by the controller 340, the autonomous driving of the autonomous vehicle from being activated, when the climate state is determined as the inclement weather state and when the autonomous vehicle is not performing the autonomous driving,

As an example, the controlling (S840) of the autonomous vehicle and the device included in the autonomous vehicle based on the determined information may include transmitting, by the controller 340, a signal corresponding to the inclement weather to an external device through V2X communication, displaying information related to the inclement weather on a display of the autonomous vehicle, or may operate a windshield wiper of the autonomous vehicle, when the climate state is determined as the inclement weather state.

The operations of the method or the algorithm described in connection with the exemplary embodiments included herein may be embodied directly in hardware or a software module executed by the processor or in a combination thereof. The software module may reside on a storage medium (that is, the memory/or the storage) such as a RAM, a flash memory, a ROM, an EPROM, an EEPROM, a register, a hard disk, a removable disk, and a CD-ROM.

The exemplary storage medium may be coupled to the processor, and the processor may read information out of the storage medium and may record information in the storage medium. Alternatively, the storage medium may be integrated with the processor. The processor and the storage medium may reside in an application specific integrated circuit (ASIC). The ASIC may reside within a user terminal. In another case, the processor and the storage medium may reside in the user terminal as separate components.

A description will be provided of effects of the autonomous driving control apparatus and the method thereof according to various exemplary embodiments of the present invention.

According to at least one of embodiments of the present invention, the apparatus and the method may be provided to control an autonomous vehicle depending on weather.

Furthermore, according to at least one of embodiments of the present invention, the autonomous driving control apparatus and the method thereof may be provided to detect inclement weather and request the driver to switch control authority, when it is determined that it is impossible to maintain an autonomous driving function, thus improving stability of the autonomous driving system.

Furthermore, according to at least one of embodiments of the present invention, the autonomous driving control apparatus and the method thereof may be provided to limit a speed or an acceleration of the autonomous vehicle in an autonomous driving mode, when detecting inclement weather, to reduce the risk of accident and prevent big accident to ensure safety of the driver.

Furthermore, according to at least one of embodiments of the present invention, the autonomous driving control apparatus and the method thereof may be provided to perform a minimum risk maneuver (MRM), when detecting inclement weather, to propose a safe function to the passenger of the autonomous vehicle.

Furthermore, according to at least one of embodiments of the present invention, the autonomous driving control apparatus and the method thereof may be provided to provide the driver or another vehicle with information related to inclement weather, using an additional device or a display device of the autonomous vehicle, when detecting the inclement weather, to increase safety and convenience of the driver or a user of the other vehicle.

Furthermore, various effects ascertained directly or indirectly through the present invention may be provided.

Hereinabove, although the present invention has been described with reference to exemplary embodiments and the accompanying drawings, the present invention is not limited thereto, but may be variously modified and altered by those skilled in the art to which various exemplary embodiments of the present invention pertains without departing from the spirit and scope of the present invention claimed in the following claims.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An autonomous driving control apparatus, comprising:
a sensing device provided in an autonomous vehicle to obtain at least one of vehicle information of the autonomous vehicle or weather information around the autonomous vehicle;
an inclement weather determining device configured to determine whether a climate state is an inclement weather state, according to the at least one of the vehicle information of the autonomous vehicle or the weather information around the autonomous vehicle; and
an autonomous driving mode determining device configured to determine an autonomous driving mode of the autonomous vehicle depending on whether the climate state is the inclement weather state.

2. The autonomous driving control apparatus of claim 1,
wherein the vehicle information includes an image around the autonomous vehicle, sensing information of a light detection and ranging (LIDAR) of the autonomous vehicle, sensing information of a rain sensor of the autonomous vehicle, an operation state of a windshield wiper of the autonomous vehicle, an acceleration of the autonomous vehicle, or wheel sensor information of the autonomous vehicle, and
wherein the weather information includes weather information obtained through vehicle to everything (V2X) communication.

3. The autonomous driving control apparatus of claim 1,
wherein the autonomous driving mode determining device is configured to limit at least one of a speed or an acceleration of the autonomous vehicle or to request a user to switch control authority of the autonomous vehicle, when the climate state is determined by the inclement weather determining device as the inclement weather state and when the autonomous vehicle is performing autonomous driving thereof and the autonomous driving mode determining device is configured to prohibit the autonomous driving of the autonomous vehicle from being activated, when the climate state is determined by the inclement weather determining device as the inclement weather state and when the autonomous vehicle is not performing the autonomous driving.

4. The autonomous driving control apparatus of claim 1, further including:
a controller configured to transmit a signal corresponding to inclement weather to an external device through V2X communication, to display information related to the inclement weather on a display of the autonomous vehicle, or to operate a windshield wiper of the autonomous vehicle, when the climate state is determined by the inclement weather determining device as the inclement weather state.

5. The autonomous driving control apparatus of claim 1,
wherein the inclement weather determining device is configured to analyze an image around the autonomous vehicle, the image including at least one of an image in front of the autonomous vehicle, an image behind the autonomous vehicle, an image at a predetermined side of the autonomous vehicle, or an image in a ground direction, by a learning model based on machine learning, the learning model being previously learned, to determine whether the climate state is the inclement weather state.

6. The autonomous driving control apparatus of claim 1,
wherein the inclement weather determining device is configured to analyze sensing information of a LIDAR of the autonomous vehicle by a learning model based on machine learning, the learning model being previously learned, to determine whether the climate state is the inclement weather state or configured to determine whether the climate state is the inclement weather state, based on whether a value of a noise component corresponding to the sensing information of the LIDAR is greater than a threshold of a predetermined noise component.

7. The autonomous driving control apparatus of claim 6,
wherein the inclement weather determining device is configured to detect the noise component according to at least one of a change in position of a centroid component of a group obtained by clustering points detected by the LIDAR, a number of clustered groups, or a change in the number of the clustered groups.

8. The autonomous driving control apparatus of claim 1,
wherein the inclement weather determining device is configured to determine whether the climate state is the inclement weather state, according to at least one of a reflectivity of light radiated to a windshield of the autonomous vehicle, the reflectivity being detected by a rain sensor, or a change in the reflectivity.

9. The autonomous driving control apparatus of claim 8,
wherein the inclement weather determining device is configured to determine the climate state as the inclement weather state, when the reflectivity for all of the windshield is greater than a predetermined first threshold reflectivity or when the reflectivity for a portion of the windshield is greater than a predetermined second threshold reflectivity.

10. The autonomous driving control apparatus of claim 1,
wherein the inclement weather determining device is configured to determine the climate state as the inclement weather state, when a windshield wiper of the autonomous vehicle operates greater than a predetermined threshold time in a high state.

11. The autonomous driving control apparatus of claim 1,
wherein the inclement weather determining device is configured to determine the climate state as the inclement weather state, when a degree of slip of the autonomous vehicle, the degree being determined according to at least one of acceleration or wheel sensor information of the autonomous vehicle, is greater than a predetermined threshold of slip.

12. The autonomous driving control apparatus of claim 1,
wherein the inclement weather determining device is configured to determine the climate state as the inclement weather state, when one or more values of a parameter corresponding to an image around the autonomous vehicle, a parameter corresponding to sensing information of a Light Detection and Ranging of the autonomous vehicle, a parameter corresponding to sensing information of a rain sensor of the autonomous vehicle, a parameter corresponding to an operation state of a windshield wiper of the autonomous vehicle, a parameter corresponding to weather information obtained through V2X communication, or a parameter corresponding to at least one of an acceleration of the autonomous vehicle or wheel sensor information of the autonomous vehicle are greater than a predetermined first threshold preset for each parameter or when two or more parameters are greater than a predetermined second threshold preset for each parameter.

13. An autonomous driving control method, comprising:
obtaining, by a sensing device provided in an autonomous vehicle, at least one of vehicle information of the autonomous vehicle or weather information around the autonomous vehicle;
determining, by an inclement weather determining device, whether a climate state is an inclement weather state, according to the at least one of the vehicle information of the autonomous vehicle or the weather information around the autonomous vehicle; and
determining, by an autonomous driving mode determining device, an autonomous driving mode of the autonomous vehicle depending on whether the climate state is the inclement weather state.

14. The autonomous driving control method of claim 13, wherein the determining of the autonomous driving mode of the autonomous vehicle depending on whether the climate state is the inclement weather state by the autonomous driving mode determining device includes:
limiting, by the autonomous driving mode determining device, at least one of a speed or an acceleration of the autonomous vehicle or requesting a user to switch control authority of the autonomous vehicle, when the climate state is determined by the inclement weather determining device as the inclement weather state and when the autonomous vehicle is performing autonomous driving thereof; and
prohibiting, by the autonomous driving mode determining device, the autonomous driving of the autonomous vehicle from being activated, when the climate state is determined by the inclement weather determining device as the inclement weather state and when the autonomous vehicle is not performing the autonomous driving.

15. The autonomous driving control method of claim 13, further including:
transmitting, by a controller, a signal corresponding to inclement weather to an external device through vehicle to everything (V2X) communication, displaying, by the controller, information related to the inclement weather on a display of the autonomous vehicle, or operating, by the controller, a windshield wiper of the autonomous vehicle, when the climate state is determined by the inclement weather determining device as the inclement weather state.

16. The autonomous driving control method of claim 13, wherein the determining of whether the climate state is the inclement weather state by the inclement weather determining device includes:
analyzing, by the inclement weather determining device, an image around the autonomous vehicle, the image including at least one of an image in front of the autonomous vehicle, an image behind the autonomous vehicle, an image at a predetermined side of the autonomous vehicle, or an image in a ground direction, by a learning model based on machine learning, the learning model being previously learned, to determine whether the climate state is the inclement weather state.

17. The autonomous driving control method of claim 13, wherein the determining of whether the climate state is the inclement weather state by the inclement weather determining device includes:
analyzing, by the inclement weather determining device, sensing information of a Light Detection and Ranging (LiDAR) of the autonomous vehicle by a learning model based on machine learning, the learning model being previously learned, to determine whether the climate state is the inclement weather state or determining, by the inclement weather determining device, whether the climate state is the inclement weather state, based on whether a value of a noise component corresponding to the sensing information of the LIDAR is greater than a threshold of a predetermined noise component.

18. The autonomous driving control method of claim 13, wherein the determining of whether the climate state is the inclement weather state by the inclement weather determining device includes:
determining, by the inclement weather determining device, whether the climate state is the inclement weather state, according to at least one of a reflectivity of light radiated to a windshield of the autonomous vehicle, the reflectivity being detected by a rain sensor, or a change in the reflectivity.

19. The autonomous driving control method of claim 13, wherein the determining of whether the climate state is the inclement weather state by the inclement weather determining device includes:
determining, by the inclement weather determining device, the climate state as the inclement weather state, when a windshield wiper of the autonomous vehicle operates greater than a predetermined threshold time in a high state.

20. The autonomous driving control method of claim 13, wherein the determining of whether the climate state is the inclement weather state by the inclement weather determining device includes:
determining, by the inclement weather determining device, the climate state as the inclement weather state, when a degree of slip of the autonomous vehicle, the degree being determined according to at least one of acceleration or wheel sensor information of the autonomous vehicle, is greater than a predetermined threshold of slip.
